(19) United States
(12) Patent Application Publication
(10) Pub. No.: US 2024/0071265 A1
(43) Pub. Date: Feb. 29, 2024

(54) Enhanced Visibility Address Sign Device

(71) Applicant: George Castlen, Lexington, KY (US)

(72) Inventor: George Castlen, Lexington, KY (US)

(21) Appl. No.: 17/896,023

(22) Filed: Aug. 25, 2022

(51) Int. Cl. G09F 13/00; G09F 13/04

(52) U.S. Cl. CPC G09F 13/005; G09F 13/0418

(57) ABSTRACT

An enhanced visibility address sign device for being controlled by a wireless device includes a housing having a top wall, a bottom wall, and a front wall. The front wall has a cutout where a display panel is positioned. Additionally, the housing has a back wall and an interior. An outside strip positioned on the bottom wall of the housing is illuminates an area below the bottom wall and an inside strip positioned within the interior of the housing emits a plurality of colors and illuminates the display panel. A control board is an actuator for the outside strip and the inside strip and a transceiver is in wireless communication with a mobile device thus obtaining commands from the mobile device and sending commands to the control board.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to address sign device and more particularly pertains to a new address sign device for being controlled by a wireless device.

### (2) Description of Related Art Including Information Disclosed Under 37 CFR 1.97 and 1.98

The prior art relates to address sign devices. The prior art includes a variety of address sign devices comprising a plurality of light emitting diodes for enhancing visibility of the address sign. Known prior art lacks a address sign device comprising a plurality of light emitting diodes configured for emitting a variety of colors respective to a variety of events and being controlled by a wireless device.

### BRIEF SUMMARY OF THE INVENTION

An embodiment of the disclosure meets the needs presented above by generally comprising a housing. The housing has a top wall, a bottom wall, and a front wall. The front wall has a cutout where a display panel is positioned. Additionally, the housing has a back wall being configured for mounting to a house. Moreover, the housing has an interior defining a space for holding a variety of elements. An outside strip positioned on the bottom wall of the housing is configured for illuminating an area below the bottom wall. Furthermore, an inside strip is positioned within the interior of the housing and is configured for emitting a plurality of colors and illuminating the display panel of the front wall. A control board is positioned within the interior of the housing and is configured for being an actuator for the outside strip and the inside strip. In addition, a transceiver is in electric communication with the control board and is configured for being in wireless communication with a mobile device wherein obtaining commands from the mobile device and sending commands to the control board. A pair of batteries is nested within a battery compartment of the housing. The pair of batteries is a reservoir for electricity and each of the batteries are in electric communication with the control board.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of an enhanced visibility address sign device according to an embodiment of the disclosure.

FIG. 2 is a front isometric view of an embodiment of the disclosure.

FIG. 3 is a front view of an embodiment of the disclosure.

FIG. 4 is a bottom view of an embodiment of the disclosure.

FIG. 5 is a side view of an embodiment of the disclosure.

FIG. 6 is a cross-sectional view of an embodiment of the disclosure taken from FIG. 3 of Line 6-6.

FIG. 7 is an in-use view of an embodiment of the disclosure.

### DETAILED DESCRIPTION OF THE INVENTION

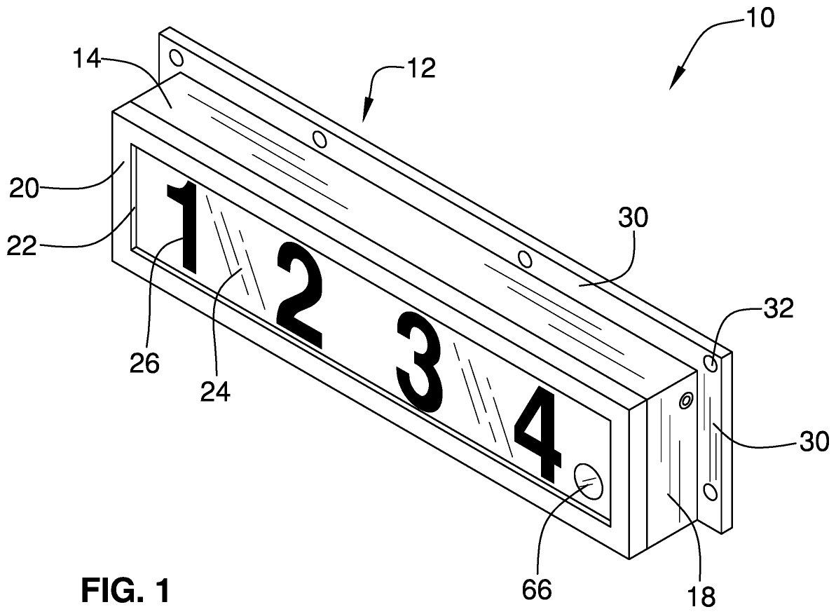

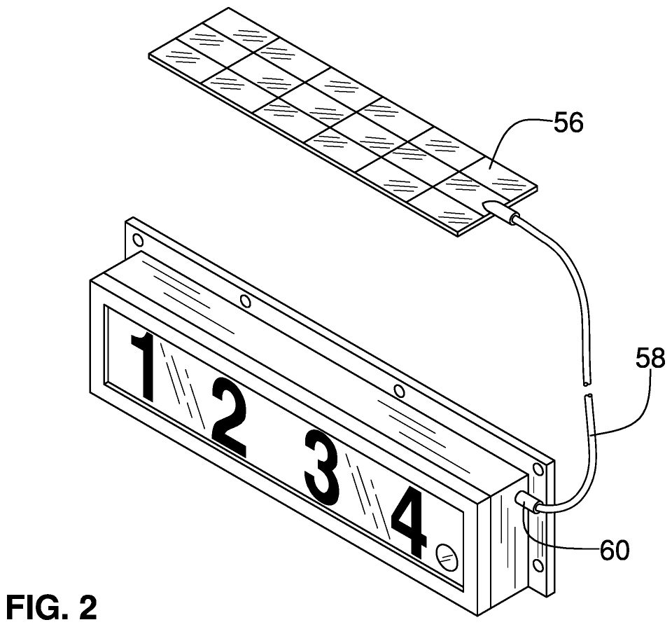

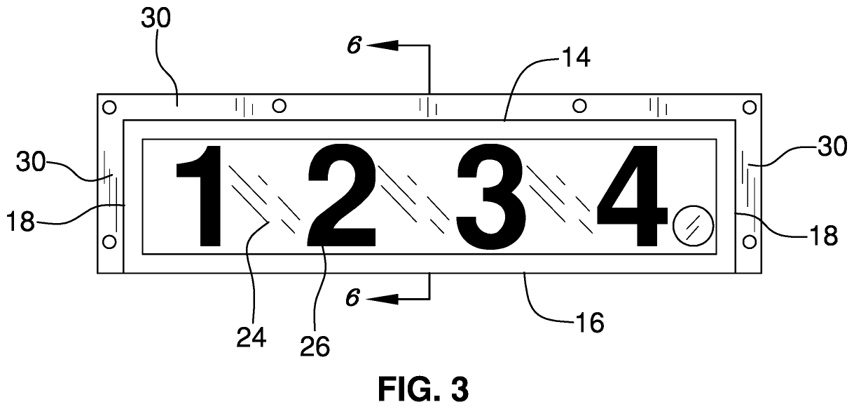

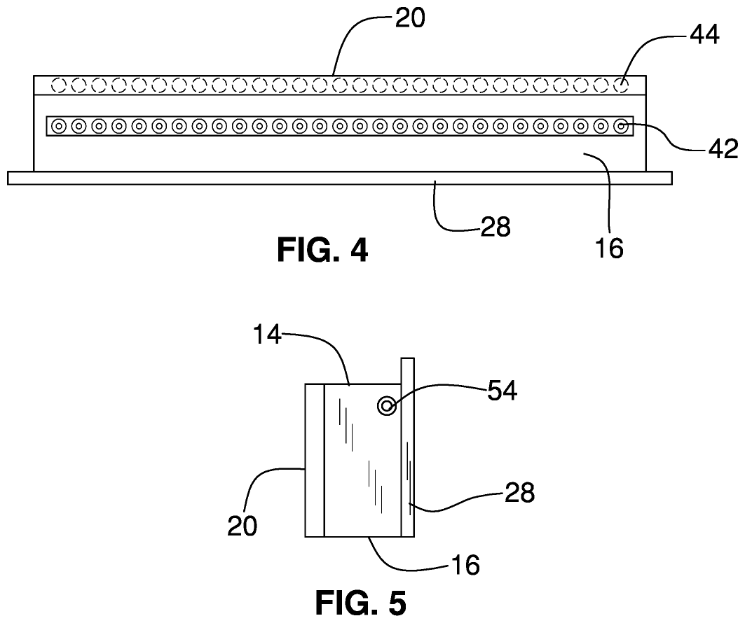

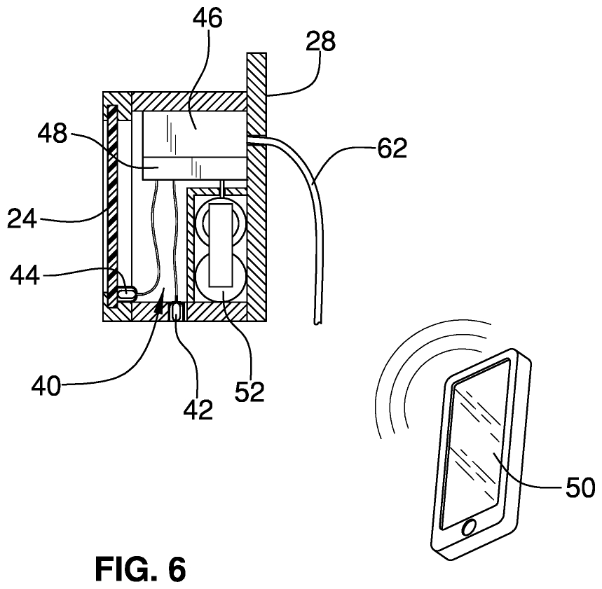

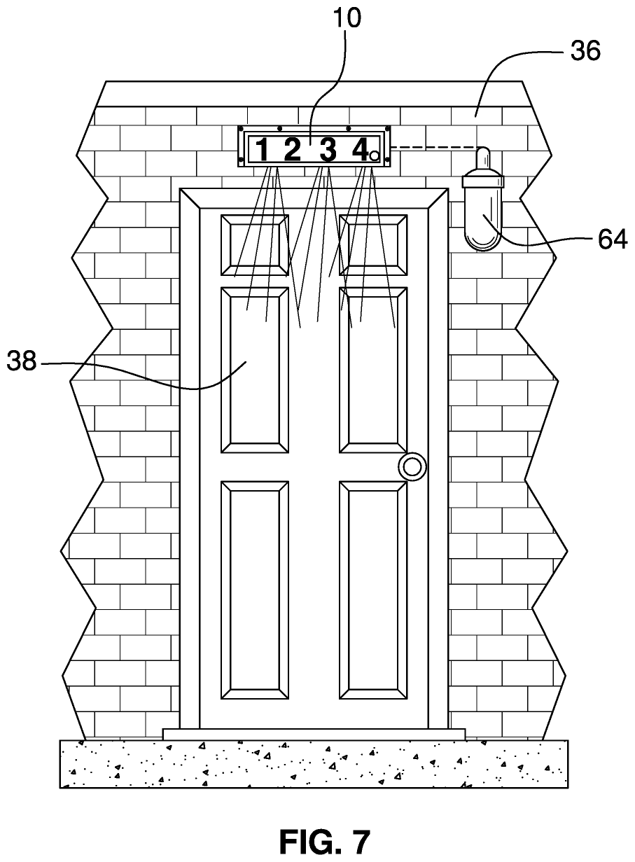

With reference now to the drawings, and in particular to FIGS. 1 through 7 thereof, a new address sign device embodying the principles and concepts of an embodiment of the disclosure and generally designated by the reference numeral 10 will be described.

As best illustrated in FIGS. 1 through 7, the enhanced visibility address sign device 10 generally comprises a housing 12. The housing 12 includes a top wall 14, a bottom wall 16, a pair of side walls 18, and a front wall 20. The front wall 20 has a cutout 22 where a display panel 24 is positioned and has an address 26 being an arrangement of numbers respective to the address of the user. Additionally, the housing 12 has a back wall 28 comprising a plurality of flanges 30 being positioned adjacent to the pair of side walls 18 and the top wall 14. The plurality of flanges 30 has a plurality of holes 32 being configured for nesting a plurality of bolts 34 and securing to a surface wherein the back wall 28 is configured for mounting to a house 36. The housing 12 is configured for mounting above the front door 38 of the house 36 wherein the housing 12 is visible to a driver. Furthermore, the housing 12 has an interior 40 defining a space for holding a variety of elements.

An outside strip 42 positioned on the bottom wall 16 of the housing 12 is a plurality of light emitting diodes being configured for emitting a white color. The outside strip 42 is configured for illuminating an area below the bottom wall 16, wherein the outside strip 42 illuminates the front door 38 of the house 36 for the driver. Alternately, an inside strip 44 is positioned within the interior 40 of the housing 12 and is positioned adjacent to the display panel 24 of the front wall 20. The inside strip 44 is a plurality of light emitting diodes such as the outside strip 42, yet the inside strip 44 is configured for emitting a plurality of colors. Each of the colors can be configured to illuminate the display panel 24 of the front wall 20.

A control board 46 is positioned within the interior 40 of the housing 12 and is in electric communication with the outside strip 42 and the inside strip 44. The control board 46 is a microprocessor circuit board configured for being an actuator for the outside strip 42 and the inside strip 44. The control board 46 obtains commands and executes actions for the enhanced visibility address sign device 10. In addition, a transceiver 48 is in electric communication with the control board 46 and is configured for being in wireless communication with a mobile device 50. The mobile device 50 is configured for being a smart phone wherein the transceiver 48 obtains commands from the mobile device 50 and sends commands to the control board 46. The commands include changing the color being emitting from the inside strip 44, or turning the inside strip 44 and the outside strip 42 on or off.

A pair of batteries 52 is nested within a battery compartment positioned within the interior 40 of the housing 12. The pair of batteries 52 is a reservoir for electricity and the pair of batteries 52 is in electric communication with the control board 46 wherein the pair of batteries 52 provides electricity to the control board 46. The pair of batteries 52 is rechargeable and has a port 54 being an electrical plug input positioned on a first side wall of the pair of side walls 18. A solar panel 56 is in electric communication with the pair of batteries 52 and comprises a plurality of photovoltaic cells being configured for transferring sunlight into electricity. The solar panel 56 has a cord 58 including an electrical plug 60 being complementary to the port 54 of the pair of batteries 52. The electrical plug 60 can be inserted into the port 54 to provide electricity from the solar panel 56 to the pair of batteries 52.

Moreover, a power cord 62 is in electric communication with the control board 46. The power cord 62 protrudes out from the back wall 28 of the housing 12 and is configured for being in electric communication with a light fixture 64 of the house 36. The power cord 62 receives electricity from the light fixture 64 wherein when the light fixture 64 and the enhanced visibility address sign device 10 can actuated on or off simultaneously. Additionally, an indicator 66 is positioned on the display panel 24 of the front wall 20 of the housing 12. The indicator 66 is a light being configured for being positioned on the display panel 24 proximate relative to a driveway of the house 36 wherein signifying a location of the driveway. The driver can see the indicator 66 being positioned either on a left side or a right side of the display panel 24 to determine the positioning of the driveway relative to the house 36.

In use, the pair of batteries 52 of the enhanced visibility address sign device 10 can receive electricity by engaging the power cord 62 with the light fixture 64 or by engaging the electrical plug 60 of the solar panel 56 with the port 54. The user can connect the mobile device 50 to be in wireless communication with the transceiver 48 of the control board 46 wherein the user can perform commands on the enhanced visibility address sign device 10 wirelessly. The user can activate the outside strip 42 to emit a white light to enhance visibility of the front door 38 of the house 36. Furthermore, the user can emit a respective one of the plurality of colors of the inside light 44 upon the display panel 24 for enhancing visibility of the address 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An illuminated address sign device configured for enhancing visibility of an address sign to drivers, the illuminated address sign device comprising:
a housing having a top wall and a bottom wall, the housing having a front wall, the front wall having a cutout, a display panel being positioned within the cutout of the front wall, the housing having a back wall, the back wall being configured for mounting to a vertical outdoor surface of a house, the housing having an interior, the interior defining a space for holding a variety of elements;
an outside strip positioned on the bottom wall of the housing, the outside strip being configured for illuminating an area below the bottom wall;
an inside strip being positioned within the interior of the housing, the inside strip being configured for emitting a plurality of colors, the inside strip being configured for illuminating the display panel of the front wall;
a control board being positioned within the interior of the housing, the control board being configured for being an actuator for the outside strip and the inside strip;
a transceiver being in electric communication with the control board, the transceiver being configured for being in wireless communication with a mobile device, the transceiver obtaining commands from the mobile device and sending commands to the control board; and
a pair of batteries being nested within a battery compartment of the housing, the pair of batteries being a reservoir for electricity, the pair of batteries being in electric communication with the control board.

2. The illuminated address sign device of claim 1, further comprising the housing having a pair of side walls.

3. The illuminated address sign device of claim 1, further comprising the display panel having an address.

4. The illuminated address sign device of claim 3, further comprising the address being an arrangement of numbers respective to the address of the user.

5. The illuminated address sign device of claim 2, further comprising the back wall having a plurality of flanges, the plurality of flanges being positioned adjacent to the pair of side walls and the top wall.

6. The illuminated address sign device of claim 5, further comprising the plurality of flanges having a plurality of holes the plurality of holes being configured for nesting a plurality of bolts.

7. The illuminated address sign device of claim 6, further comprising each of the bolts being configured for securing to HUH the vertical outdoor surface.

8. The illuminated address sign device of claim 1, further comprising the outside strip being a plurality of light emitting diodes.

9. The illuminated address sign device of claim 8, further comprising the outside strip being configured for emitting a white color.

10. The illuminated address sign device of claim 1, further comprising the inside strip being positioned adjacent to the display panel of the front wall.

11. The illuminated address sign device of claim 10, further comprising the inside strip being a plurality of light emitting diodes.

12. The illuminated address sign device of claim 1, further comprising the control board being in electric communication with the outside strip and the inside strip.

13. The illuminated address sign device of claim 1, farther comprising the mobile device configured for being a smart phone.

14. The illuminated address sign device of claim 2, further comprising the battery compartment being positioned within the interior of the housing.

15. The illuminated address sign device of claim 14, further comprising the pair of batteries being rechargeable, the battery having a port, the port being an electrical plug input.

16. The illuminated address sign device of claim 15, further comprising the port being positioned on a first side wall of the pair of side walls.

17. The illuminated address sign device of claim 15, further comprising a solar panel being in electric communication with the pair of batteries, the solar panel comprising a plurality of photovoltaic cells, each of the photovoltaic cells being configured for transferring sunlight into electricity, the solar panel having a cord, the cord having an electrical plug, the electrical plug of the solar panel being complementary to the port of the pair of batteries.

18. The illuminated address sign device of claim 1, further comprising a power cord being in electric communication with the control board, the power cord protruding out from the back wall of the housing, the power cord being configured for being in electric communication with a light fixture of the house.

19. The illuminated address sign device of claim 1, further comprising an indicator being positioned on the display panel of the front wall of the housing, the indicator being a light, the indicator being configured for being positioned on the display panel proximate relative to a driveway of the house wherein signifying a location of the driveway.

20. An illuminated address sign device configured for enhancing visibility of an address sign to drivers, the illuminated address sign device comprising:
a housing having a top wall and a bottom wall, the housing having a pair of side walls, the housing having a front wall, the front wall having a cutout, a display panel being positioned within the cutout of the front wall, the display panel having an address, the address being an arrangement of numbers respective to the address of the user, the housing having a back wall, the back wall having a plurality of flanges, the plurality of flanges being positioned adjacent to the pair of side walls and the top wall, the plurality of flanges having a plurality of holes, the plurality of holes being configured for nesting a plurality of bolts, each of the bolts being configured for securing to a vertical outdoor surface of a house, the back wall being configured for mounting to the vertical outdoor surface of the house, the housing having an interior, the interior defining a space for holding a variety of elements;
an outside strip positioned on the bottom wall of the housing, the outside strip being a plurality of light emitting diodes, the outside strip being configured for emitting a white color, the outside strip being configured for illuminating an area below the bottom wall;
an inside strip being positioned within the interior of the housing, the inside strip being positioned adjacent to the display panel of the front wall, the inside strip being a plurality of light emitting diodes, the inside strip being configured for emitting a plurality of colors, the inside strip being configured for illuminating the display panel of the front wall;
a control board being positioned within the interior of the housing, the control board being in electric communication with the outside strip and the inside strip, the control board being configured for being an actuator for the outside strip and the inside strip;
a transceiver being in electric communication with the control board, the transceiver being configured for being in wireless communication with a mobile device, the mobile device configured for being a smart phone, the transceiver obtaining commands from the mobile device and sending commands to the control board;
a pair of batteries being nested within a battery compartment of the housing, the battery compartment being positioned within the interior of the housing, the pair of batteries being a reservoir for electricity, the pair of batteries being in electric communication with the control board, the pair of batteries being rechargeable, the battery having a port, the poll being an electrical plug input, the port being positioned on a first side wall of the pair of side walls;
a solar panel being in electric communication with the pair of batteries, the solar panel comprising a plurality of photovoltaic cells, each of the photovoltaic cells being configured for transferring sunlight into electricity, the solar panel having a cord, the cord having an electrical plug, the electrical plug of the solar panel being complementary to the port of the pair of batteries;
a power cord being in electric communication with the control board, the power cord protruding out from the back wall of the housing, the power cord being configured for being in electric communication with a light fixture of the house; and
an indicator being positioned on the display panel of the front wall of the housing, the indicator being a light, the indicator being configured for being positioned on the display panel proximate relative to a driveway of the house wherein signifying a location of the driveway.
